(19) United States
(12) Patent Application Publication
(10) Pub. No.: US 2003/0024937 A1
(43) Pub. Date: Feb. 6, 2003

(54) Inflatable cooler with at least one removable printable exterior surface

(76) Inventor: Kenneth C. Hart, Easton, CT (US)

Correspondence Address: Jay P. Sbrollini, Esq., Thomas J. Perkowski, Esq., PC, Soundview Plaza, 1266 East Main Street, Stamford, CT, 06902, US

(21) Appl. No.: 09/919,786

(22) Filed: Aug. 1, 2001

(51) Int. Cl. A47J 39/00; A47J 41/00; B65D 81/38; B65D 83/72

(52) U.S. Cl. 220/592.2

(57) ABSTRACT

An improved inflatable cooler including one or more sidewalls formed from a flexible plastic membrane having inflatable air chambers formed therein. In addition, the inflatable cooler preferably includes an inflatable lid (formed from a flexible plastic membrane having inflatable air chambers therein) and bottom wall that are integral to one or more of the sidewalls, thereby forming a one-piece construction. Such one-piece construction prevents loss of the lid and bottom wall. The air chambers of the sidewall(s) and lid act as a thermal insulating barrier for the contents of the inflatable cooler (e.g., ice or ice packs or other cooling mechanism along with food and/or drink). In addition, the inflatable cooler includes a flexible plastic membrane that is removably disposed onto the exterior surface of one or more of the sidewalls. The removable plastic membrane, when disposed onto the exterior surface of one or more of the sidewalls, forms an exterior surface of the cooler suitable for printing graphics, text, logos or other information thereon (for example via silk screening or vinyl graphic printing). Such information may be print advertising, promotional advertising or other mass merchandising and marketing information. In addition, the flexible plastic membrane is preferably shaped such that it surrounds the sidewall(s) of the cooler and provides support for stress normal to the sidewall(s). In addition, the surrounding flexible plastic membrane provides added protection to the inflatable cooler (for example, protection for piercing by foreign objects). In another aspect of the present invention, an improved inflatable cooler has a wide base design wherein the base of one or more sidewalls (formed from a flexible plastic membrane having inflatable air chambers formed therein) has a larger dimension than the top opening. Such wide base design provides added stability and improved load-bearing capabilities.

### BACKGROUND OF THE PRESENT INVENTION

1. Technical Field

The present invention relates to insulating containers for storing food or drink, and more specifically to inflatable coolers.

2. Description of the Related Art

It is difficult and costly to print graphics, text, logos or other information on the exterior surface of prior art inflatable cooler designs, such as the inflatable cooler shown in U.S. Pat. No. 4,809,352, U.S. Design Patent 333,592, and U.S. Pat. No. 4,085,785.

In addition, prior art inflatable cooler designs fail to effectively address the effects of stress normal to its walls, which limits the dimensions (including height), volume, load bearing capabilities (i.e., how much ice, beverage and/or food the design can effectively handle without failure), and/or the effective product life cycle of such designs, thus hindering the applicability of such designs in a broad range of applications.

Thus, there is a great need in the art for an improved inflatable cooler that avoids the shortcomings and drawbacks of prior art inflatable coolers.

### SUMMARY OF THE INVENTION

Accordingly, a primary object of the present invention is to provide improved inflatable coolers that are free of the shortcomings and drawbacks of prior art inflatable coolers.

Another object of the present invention is to provide a lightweight collapsible inflatable cooler for food or drink.

Another object of the present invention is to provide an inflatable cooler with unique construction for print advertising, including mass merchandising applications and marketing applications.

A further object of the present invention is to provide an inflatable cooler including at least one sidewall formed from a flexible plastic membrane having inflatable air chambers therein, wherein the air chambers act as a thermal insulating barrier for contents of the inflatable cooler.

A further object of the present invention is to provide a cooler including at least one inflatable sidewall and a flexible plastic membrane that, when removably disposed onto the exterior surface of the at least one sidewall, forms an exterior surface of the cooler suitable for printing information (such as print advertising, promotional advertising or other mass merchandising and marketing information) thereon.

Another object of the present invention is to provide a cooler including at least one inflatable sidewall and a flexible plastic membrane that, when removably disposed onto the exterior surface of the at least one sidewall, provides support for stress normal to the sidewall.

Another object of the present invention is to provide a lightweight collapsible inflatable cooler for food or drink of different sizes and shapes.

A further object of the present invention is to provide a cooler including at least one inflatable lid formed from a flexible plastic membrane, wherein dimensions of the lid is deepest in the center of the lid.

Another object of the present invention is to provide a cooler including at least one inflatable lid having a smooth top surface suitable for printing information (such as print advertising, promotional advertising or other mass merchandising and marketing information) thereon.

Another object of the present invention is to provide a cooler including at least one inflatable sidewall and an inflatable lid and bottom wall integral thereto, thereby forming a one-piece construction.

A further object of the present invention is to provide an inflatable cooler having inflatable air chambers formed by welding a flexible plastic membrane.

Another object of the present invention is to provide an inflatable cooler having inflatable air chambers formed from a flexible plastic membrane less than 10 mils thick (for example between 5-10 mils thick).

Another object of the present invention is to provide an inflatable cooler with at least one inflatable sidewall whose base has a larger dimension than a top opening formed by the at least one sidewall.

Another object of the present invention is to provide a cooler that uses inflatable air chamber(s) (preferably filled with carbon dioxide provided by a user blowing into a valve in fluid communication with the gas chamber(s)) to provide structural support of the cooler and also to provide a thermal insulating barrier for the contents of the cooler.

These and other objects of the present invention will become apparent hereinafter and in the claims to Invention.

### BRIEF DESCRIPTION OF THE DRAWINGS

For a more complete understanding of the present invention, the following Detailed Description of the Illustrative Embodiments should be read in conjunction with the accompanying Drawing.

FIG. 1A is an exploded perspective view of an exemplary embodiment of an inflatable cylindrical-shaped cooler according to the present invention, including a plurality of vertical air chambers that form the cylindrical sidewall of the cooler; and a flexible plastic membrane that, when removably disposed onto the exterior surface of the cylindrical sidewall, forms an exterior surface of the cooler suitable for printing graphics, text, logos or other information thereon (for example via silk screening or vinyl graphic printing).

FIG. 1B is a cross-sectional view of the cylindrical sidewall of the inflatable cooler of FIG. 11A illustrating the welding pattern of the flexible plastic membrane (e.g., PVC) to form the inflatable air chambers, connecting orifices and valve(s) therein.

FIG. 1C is a perspective view of the inflatable cooler of FIG. 1A wherein the flexible plastic membrane is removably disposed onto the exterior surface of the cylindrical sidewall to form an exterior surface of the cooler having graphics, text, logos or other information printed thereon (for example via silk screening or vinyl graphic printing).

FIG. 2A is a perspective view of an exemplary embodiment of an inflatable box-shaped cooler according to the present invention, including a plurality of vertical air chambers that form the sidewalls of the cooler and a flexible plastic membrane that, when removably disposed onto the exterior surface of the sidewalls, forms an exterior surface of the cooler suitable for printing graphics, text, logos or other information thereon (for example via silk screening or vinyl graphic printing).

FIG. 2B is a cross-sectional view of sidewalls, lid and bottom wall of the inflatable cooler of FIG. 2A illustrating the welding pattern of the flexible plastic membrane (e.g., PVC) to form inflatable air chambers, connecting orifices and valve(s) therein.

FIG. 3A is a perspective view of an exemplary embodiment of an inflatable cooler according to the present invention, including a plurality of horizontal air chambers that form the sidewalls of the cooler and having a wide base design (e.g., pyramid shape) wherein the base of the sidewalls has a larger dimension than the top opening (which is closed by the lid).

FIG. 3B is a cross-sectional view of sidewalls, lid and bottom wall of the inflatable cooler of FIG. 3A illustrating the welding pattern of the flexible plastic membrane (e.g., PVC) to form the inflatable air chambers, connecting orifices and valve(s) therein. FIG. 1A is an exploded perspective view of an exemplary embodiment of an inflatable cylindrical-shaped cooler according to the present invention, including a plurality of vertical air chambers that form the cylindrical sidewall of the cooler; and a flexible plastic membrane that, when removably disposed onto the exterior surface of the cylindrical sidewall, forms an exterior surface of the cooler suitable for printing graphics, text, logos or other information thereon (for example via silk screening or vinyl graphic printing).

FIG. 4 is a partial cutaway view of an exemplary embodiment of an inflatable cooler according to the present invention, including a plurality of air chambers that form the sidewall of the cooler; and an air pump integral to the base of the cooler that is manually operated (for example, with foot pressure) to pump air into the air chambers to thereby inflate the air chambers of the inflatable cooler.

### DETAILED DESCRIPTION OF THE ILLUSTRATIVE EMBODIMENTS

Referring to the figures in the accompanying Drawings, the illustrative embodiments of the inflatable cooler of the present invention will be described in greater detail, wherein like elements will be indicated using like reference numerals.

According to the present invention, an inflatable cooler includes one or more sidewalls formed from a flexible plastic membrane having inflatable air chambers therein. In addition, the inflatable cooler preferably includes an inflatable lid (formed from a flexible plastic membrane having inflatable air chambers therein) and bottom wall that are integral to one or more of the sidewalls, thereby forming a one-piece construction. Such one-piece construction prevents loss of the lid and bottom wall. The air chambers of the sidewall(s) and lid act as a thermal insulating barrier for the contents of the inflatable cooler (e.g., ice or ice packs or other cooling mechanism along with food and/or drink).

In addition, the inflatable cooler preferably includes a flexible plastic membrane that is removably disposed onto the exterior surface of one or more of the sidewalls. The removable plastic membrane, when disposed onto the exterior surface of one or more of the sidewalls, forms an exterior surface of the cooler suitable for printing graphics, text, logos or other information thereon (for example via silk screening or vinyl graphic printing). Such printed information may be print advertising, promotional advertising or other mass merchandising and marketing information. Preferably, the inflatable cooler is provided to users with such graphics, text, logos or other information printed on this flexible plastic membrane. In addition, the flexible plastic membrane is preferably shaped such that it surrounds the sidewall(s) of the cooler and provides support for stress normal to the sidewall(s) of the inflatable cooler. In addition, the surrounding flexible plastic membrane provides added protection to the inflatable cooler (for example, protection for piercing by foreign objects).

Preferably, the lid is designed to fit snuggly around the sidewall(s) of the cooler. In addition, the air chamber(s) of the lid are preferably designed so that the air chamber(s) in the center of the lid (when inflated) are the deepest therein to provide maximum insulation against overhead sun. In addition, the top surface of the lid is preferably a smooth surface suitable for printing graphics, text, logos or other information thereon (for example via silk screening or vinyl graphic printing). Again, such information may include print advertising, promotional advertising or other mass merchandising and marketing information.

In another aspect of the present invention, the inflatable cooler has a wide base design wherein the base of the sidewall(s) has a larger dimension than the top opening (which is closed by the lid). For example, this wide base design may be provided by sidewalls forming a pyramid shape or a sidewall forming a conic section. Such wide base design provides added stability and improved load-bearing capabilities.

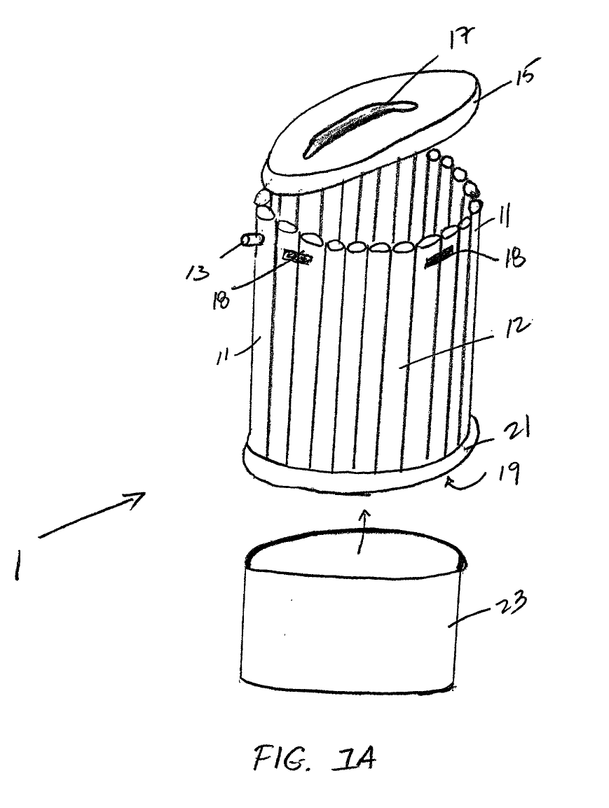

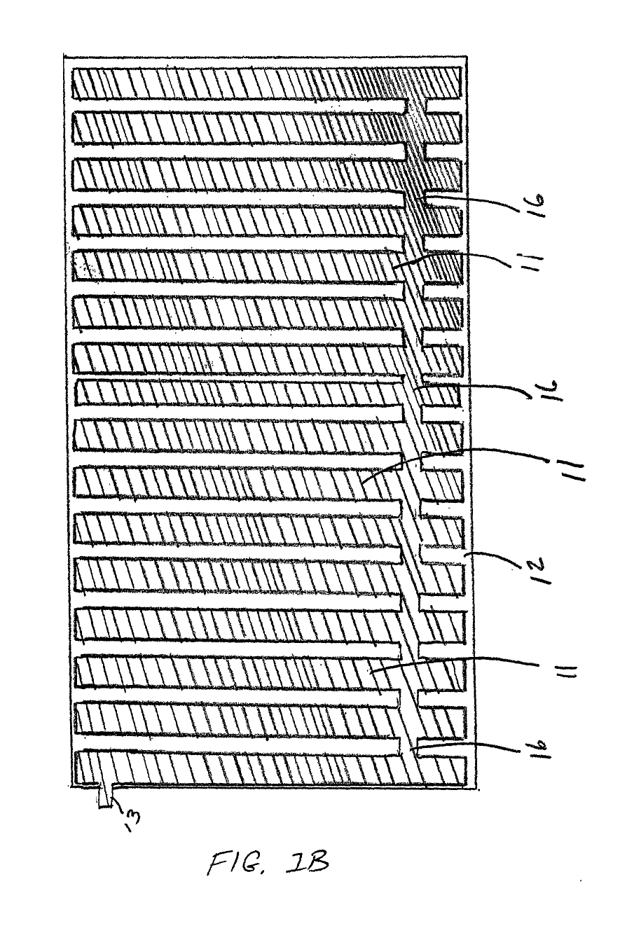

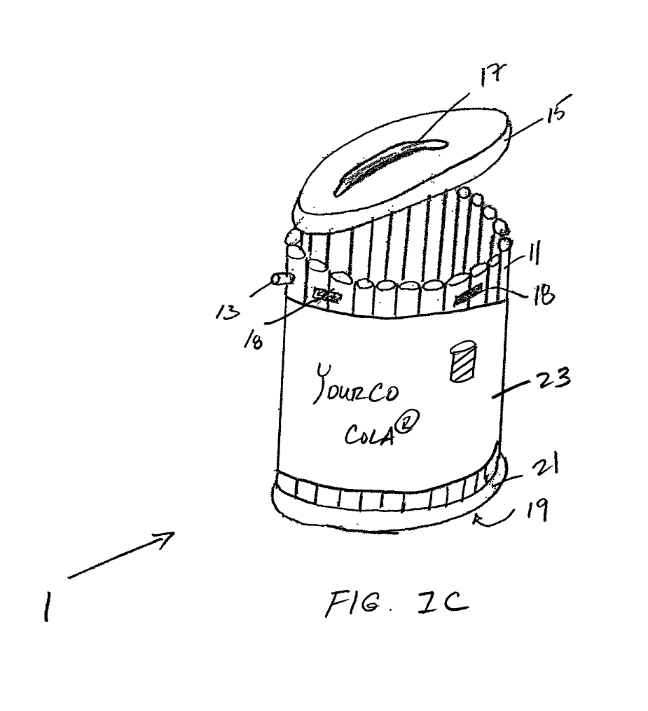

Referring now to FIG. 1A, there is shown a perspective view of an exemplary embodiment of the inflatable cooler 1 according to the present invention. The cooler 1 is made utilizing a flexible plastic membrane (such as a polyvinyl chloride (PVC) membrane that is preferably less than 10 mils thick (for example, 5-10 mils thick). A plurality of vertical air chambers 11 form the cylindrical sidewall 12 of the cooler 1. Preferably, such air chambers 11 are formed by welding (e.g., thermal welding, adhesive welding, high frequency welding) the flexible plastic membrane. The air chambers 11 (or sets of air chambers 11) are in fluid communication via connecting orifices 16 (not shown) to one or more valves 13 (one shown). Inflation and deflation of the cooler 1 is accomplished by means of the valve(s) 13. In addition, the inflatable cooler 1 includes an inflatable lid 15 (formed from a flexible plastic membrane such as PVC having inflatable air chambers therein in fluid communication with air valve means) and bottom wall 19 (formed from a flexible plastic membrane such as PVC). Preferably, the inflatable lid 15 and bottom wall 19 are integral to the cylindrical sidewall 12, thereby forming a one-piece construction. Such one-piece construction prevents loss of the lid 15 and bottom wall 19. Alternatively, the inflatable lid 15 may be removably affixed to the cylindrical sidewall via a flexible connector (such as a Velcro hinge). In addition, Velcro fasteners 18, or other suitable securing means, are located about the perimeter of the lid 15 and the cylindrical sidewall 12 for securing the lid 15 in a closed position. In addition, the bottom wall 19 preferably includes a round air chamber 21 that encircles the outside diameter of the cylindrical sidewall 12, which adds stability to the cooler 1. The air chambers of the sidewall 12 and lid 15 act as a thermal insulating barrier for the contents of the inflatable cooler (e.g., ice or ice packs or other cooling mechanism along with food and/or drink).

In addition, the inflatable cooler 1 preferably includes a flexible plastic membrane 23 that is removably disposed onto the exterior surface of the cylindrical sidewall 12. The removable plastic membrane 23, when disposed onto the exterior surface of the sidewall 12, forms an exterior surface suitable for printing graphics, text, logos or other information thereon (for example via silk screening or vinyl graphic printing). Such information may be print advertising, promotional advertising or other mass merchandising and marketing information. The inflatable cooler 1 may be provided to users with such graphics, text, logos or other information printed on this flexible plastic membrane 23 for self-assembly whereby the user positions the plastic membrane 23 such that it is disposed on the exterior surface of the cylindrical sidewall 12. FIG. 1C illustrates the final assembly of the inflatable cooler 1 wherein the flexible plastic membrane is removably disposed onto the exterior surface of the cylindrical sidewall to form an exterior surface of the cooler having graphics, text, logos or other information printed thereon (for example via silk screening or vinyl graphic printing). In addition, the flexible plastic membrane 23 is preferably shaped such that it surrounds the cylindrical sidewall 12 of the cooler 1 and provides support for stress normal to the cylindrical sidewall 12 of the inflatable cooler 1. In addition, the surrounding flexible plastic membrane 23 provides added protection to the inflatable cooler 1 (for example, protection for piercing by foreign objects).

When deflated the cooler 1 can be collapsed and placed in its protective plastic sleeve (not shown) and stored indefinitely. When the cooler 1 is in use, the protective sleeve can be opened and placed inside the cooler 1 to form a liner therein, offering added protection, strength and stability.

Preferably, the lid 15 includes a handle 17 and is designed to fit snuggly around the cylindrical sidewall 1 of the cooler 1. In addition, the air chamber(s) 11 of the lid 15 are preferably designed so that the air chambers in the center of the lid 15 (when inflated) are the deepest to provide maximum insulation against overhead sun. In addition, the top surface of the lid 15 is preferably a smooth surface suitable for printing graphics, text, logos or other information thereon (for example via silk screening or vinyl graphic printing). Such information may be print advertising, promotional advertising or other mass merchandising and marketing information. The inflatable lid 15 may include a single air chamber that is deepest in the center of lid 15 (when inflated) to provide maximum insulation against overhead sun.

FIG. 1B is a cross-sectional view of the sidewall 12 of cooler 1 of FIG. 1A illustrating an exemplary welding pattern of the flexible plastic membrane (e.g., PVC) to form the inflatable air chambers 11, connecting orifices 16 and valve(s) 13 (one shown), therein. Such welding may be accomplished using thermal welding, adhesive welding or high frequency welding (such as ultrasonic welding) techniques as is well know in the art.

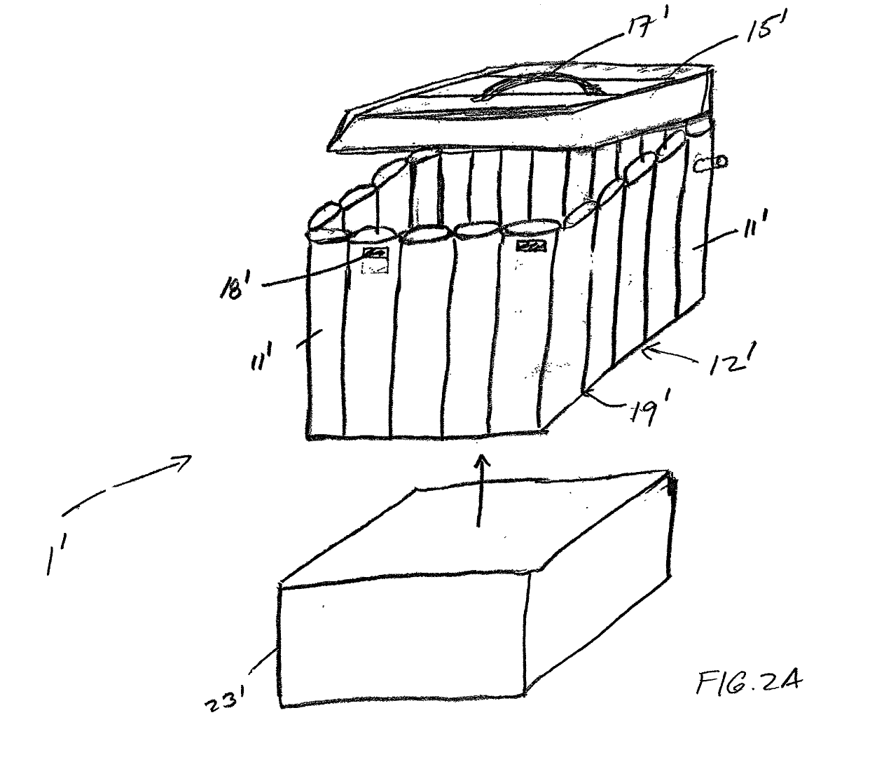

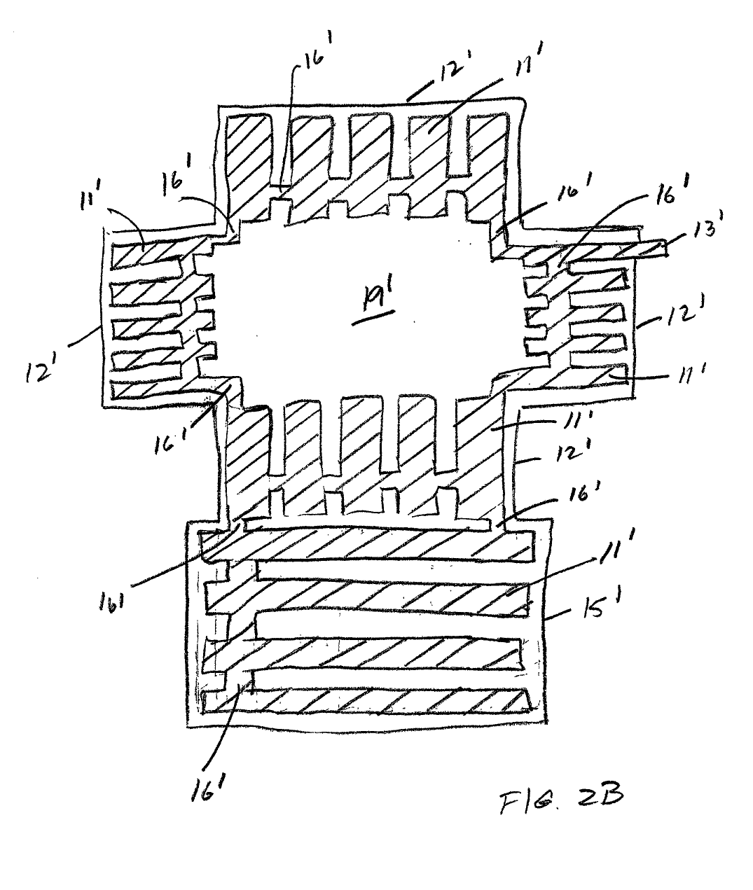

Referring now to FIG. 2A, there is shown a perspective view of an exemplary embodiment of the inflatable cooler 1 according to the present invention. The cooler 1′ is made utilizing a flexible plastic membrane (such as a polyvinyl chloride (PVC) membrane that is preferably less than 10 mils thick (for example, 5-10 mils thick). A plurality of vertical air chambers 11′ form the sidewalls 12′ of the cooler 1′. Preferably, such air chambers 11′ are formed by welding (e.g., thermal welding, adhesive welding, high frequency welding) the flexible plastic membrane. The air chambers 11′ (or sets of air chambers 11′) are in fluid communication via connecting orifices 16′ to one or more valves 13′ (one shown). Inflation and deflation of the cooler 1′ is accomplished by means of the valve(s) 13′. In addition, the inflatable cooler 1′ includes an inflatable lid 15′ (formed from a flexible plastic membrane such as PVC having inflatable air chambers 11′ therein in fluid communication with air valve means) and bottom wall 19′ (formed from a flexible plastic membrane such as PVC). Preferably, the inflatable lid 15′ and bottom wall 19′ are integral to the sidewalls 12′, thereby forming a one-piece construction. Such one-piece construction prevents loss of the lid 15′ and bottom wall 19′. Alternatively, the inflatable lid 15′ may be removably affixed to one (or more) sidewall 12′ via a flexible connector (such as a Velcro hinge). In addition, Velcro fasteners 18′, or other suitable securing means, are located about the perimeter of the lid 15′ and the sidewall(s) 12′ for securing the lid 15′ in a closed position. The air chambers 11′ of the sidewalls 12 and lid 15′ act as a thermal insulating barrier for the contents (e.g., ice or ice packs or other cooling mechanism along with food and/or drink) of the cooler 1′.

In addition, the inflatable cooler 1′ preferably includes a flexible plastic membrane 23′ that is removably disposed onto the exterior surface of the sidewalls 12′. The removable plastic membrane 23′, when disposed onto the exterior surface of the sidewalls 12′, forms an exterior surface suitable for printing graphics, text, logos or other information thereon (for example via silk screening or vinyl graphic printing). Such information may be print advertising, promotional advertising or other mass merchandising and marketing information. The inflatable cooler 1′ may be provided to users with such graphics, text, logos or other information printed on this flexible plastic membrane 23′ for self-assembly whereby the user positions the plastic membrane 23′ such that it is disposed on the exterior surface of the sidewalls 12′. In addition, the flexible plastic membrane 23′ is preferably shaped such that it surrounds the sidewalls 12′ of the cooler 1′ and provides support for stress normal to the sidewalls 12′ of the inflatable cooler 1′. In addition, the surrounding flexible plastic membrane 23′ provides added protection to the inflatable cooler 1′ (for example, protection for piercing by foreign objects).

When deflated the cooler 1′ can be collapsed and placed in its protective plastic sleeve (not shown) and stored indefinitely. When the cooler 1′ is in use, the protective sleeve can be opened and placed inside the cooler 1′ to form a liner therein, offering added protection, strength and stability.

Preferably, the lid 15′ includes a handle 17′ and is designed to fit snuggly around the sidewalls 12′ of the cooler 1′. In addition, the air chamber(s) 11′ of the lid 15′ are preferably designed so that the air chamber(s) in the center of the lid 15′ are the deepest (when inflated) to provide maximum insulation against overhead sun. In addition, the top surface of the lid 15′ is preferably a smooth surface suitable for printing graphics, text, logos or other information thereon (for example via silk screening or vinyl graphic printing). Such information may be print advertising, promotional advertising or other mass merchandising and marketing information.

FIG. 2B is a cross-sectional view of the sidewalls 12′, lid 15′ and bottom wall 19′ of cooler 1′ of FIG. 2A illustrating an exemplary welding pattern of the flexible plastic membrane (e.g., PVC) to form the inflatable air chambers 11′, connecting orifices 16′ and valve(s) 13′ (one shown), therein. Such welding may be accomplished using thermal welding, adhesive welding or high frequency welding (such as ultrasonic welding) techniques as is well know in the art.

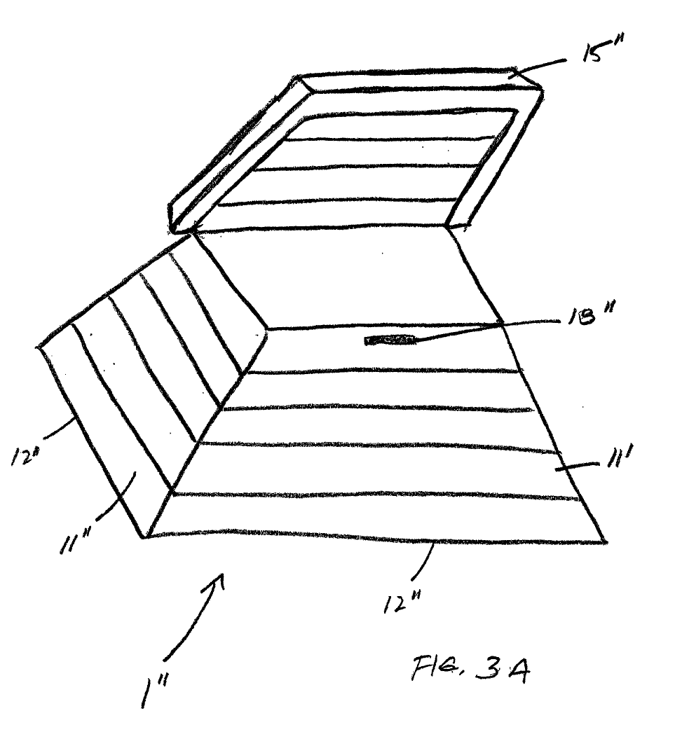

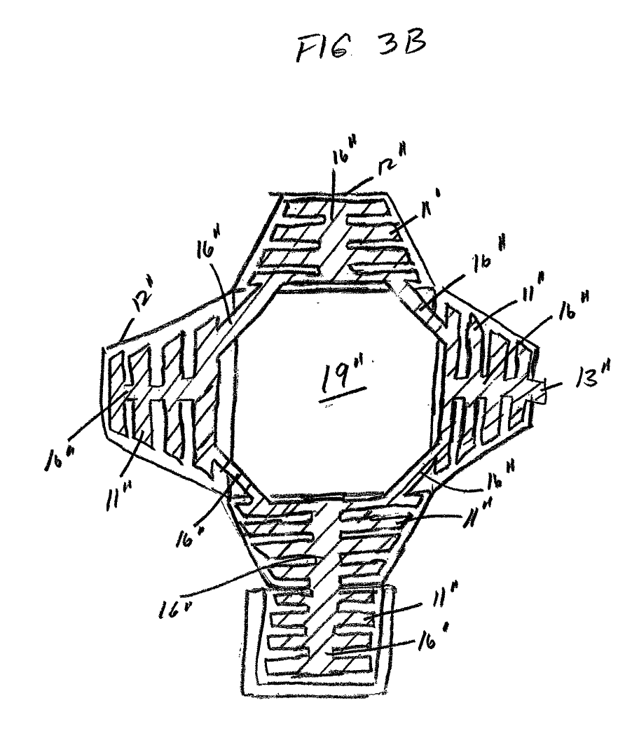

Referring now to FIG. 3A, there is shown a perspective view of an exemplary embodiment of the inflatable cooler 1″ according to the present invention. The cooler 1″ is made utilizing a flexible plastic membrane (such as a polyvinyl chloride (PVC) membrane that is preferably less than 10 mils thick (for example, 5-10 mils thick). A plurality of horizontal air chambers 11″ form the sidewalls 12″of the cooler 1″. Preferably, such air chambers 11″ are formed by welding (e.g., thermal welding, adhesive welding, high frequency welding) the flexible plastic membrane. The air chambers 11″(or sets of air chambers 11′) are in fluid communication via connecting orifices 16″ to one or more valves 13″ (not shown). Inflation and deflation of the cooler 1″ is accomplished by means of the valve(s) 13″. In addition, the inflatable cooler 1″ includes an inflatable lid 15″ (formed from a flexible plastic membrane such as PVC having inflatable air chambers 11″therein in fluid communication with air valve means) and bottom wall 19″ (formed from a flexible plastic membrane such as PVC). Preferably, the inflatable lid 15″ and bottom wall 19″ are integral to the sidewalls 12″, thereby forming a one-piece construction. Such one-piece construction prevents loss of the lid 15″ and bottom wall 19″. Alternatively, the inflatable lid 15″ may be removably affixed to one (or more) sidewall 12″ via a flexible connector (such as a Velcro hinge). In addition, Velcro fasteners 18″, or other suitable securing means, are located about the perimeter of the lid 15″ and the sidewall(s) 12″ for securing the lid 15″ in a closed position. The air chambers 11″ of the sidewalls 12″ and lid 15″ act as a thermal insulating barrier for the contents (e.g., ice or ice packs or other cooling mechanism along with food and/or drink) of the cooler 1″.

In addition, the inflatable cooler 1″ preferably includes a flexible plastic membrane 23″ (not shown) that is removably disposed onto the exterior surface of the sidewalls 12″. The flexible plastic membrane 23″, when disposed onto the exterior surface of the sidewalls 12″, forms an exterior surface suitable for printing graphics, text, logos or other information thereon (for example via silk screening or vinyl graphic printing). Such information may be print advertising, promotional advertising or other mass merchandising and marketing information. logos or other information thereon (for example via silk screening or vinyl graphic printing). The inflatable cooler 1″is provided to users with such graphics, text, logos or other information printed on this flexible plastic membrane 23″ for self-assembly whereby the user positions the plastic membrane 23″ such that it is disposed on the exterior surface of the sidewalls 12″. The flexible plastic membrane 23″ is preferably shaped such that it surrounds the sidewalls 12″ of the cooler 1″ and provides support for stress normal to the sidewalls 12″ of the inflatable cooler 1″. In addition, the surrounding flexible plastic membrane 23″ provides added protection to the inflatable cooler 1″ (for example, protection for piercing by foreign objects).

When deflated the cooler 1″ can be collapsed and placed in its protective plastic sleeve (not shown) and stored indefinitely. When the cooler 1″ is in use, the protective sleeve can be opened and placed inside the cooler 1′ to form a liner therein, offering added protection, strength and stability.

Preferably, the lid 15″ includes a handle 17″ (not shown) and is designed to fit snuggly around the sidewalls 12″ of the cooler 1″. In addition, the air chamber(s) 11″ of the lid 15″ are preferably designed so that the air chamber(s) in the center of the lid 15″ is deepest to provide maximum insulation against overhead sun. In addition, the top surface of the lid 15″ is preferably a smooth surface suitable for printing graphics, text, logos or other information thereon (for example via silk screening or vinyl graphic printing). Such information may be print advertising, promotional advertising or other mass merchandising and marketing information.

As shown, the inflatable cooler 1″ of FIGS. 3A and 3B has a wide base design (e.g., pyramid shape) wherein the base of the sidewall(s) has a larger dimension than the top opening (which is closed by the lid 15″). Alternatively, such wide base design may be provided by sidewalls forming a conic section or other geometry. Importantly, such wide base design provides added stability and improved load-bearing capabilities.

FIG. 3B is a cross-sectional view of the sidewalls 12″, lid 15″ and bottom wall 19″ of cooler 1″ of FIG. 3A illustrating an exemplary welding pattern of the flexible plastic membrane (e.g., PVC) to form the inflatable air chambers 11″, connecting orifices 16″ and valve(s) 13″ (one shown), therein. Such welding may be accomplished using thermal welding, adhesive welding or high frequency welding (such as ultrasonic welding) techniques as is well know in the art.

The inflatable coolers of the present invention as described above utilize inflatable air chamber(s) integral to one or more sidewalls of the cooler to provide structural support of the cooler and to provide a thermal insulating barrier for the contents of the cooler (e.g., ice or ice packs or other cooling mechanism along with food and/or drink). The air chamber(s) are preferably inflated with carbon dioxide by a user blowing into one or more valves in fluid communication with the air chamber(s) of the cooler. Alternatively, the air chamber(s) may be inflated with an external air pump (such as an hand-operated air pump, foot-operated air pump or electric air pump) that pumps air into one or more valves in fluid communication with the air chamber(s) of the cooler.

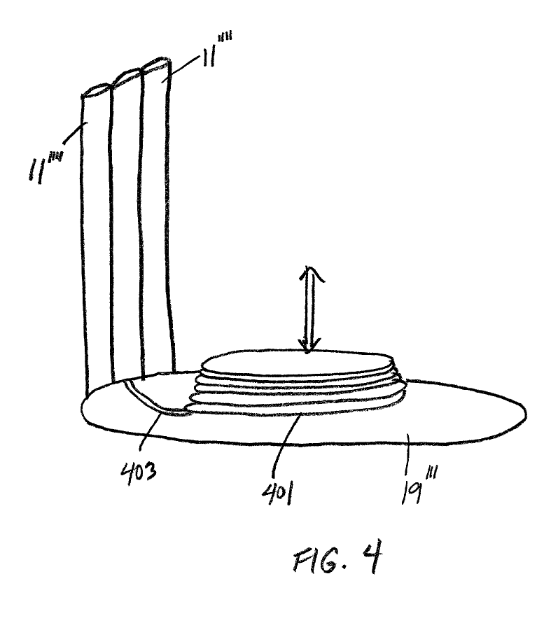

Alternatively, the air chamber(s) of the cooler may be inflated with an integral air pump (such as a bellows-type air pump 401 integral to the base 19′″ of the cooler as shown in FIG. 4) that pumps air into the air chamber(s) of the cooler. In this illustrative embodiment, a user utilizes foot pressure (illustrated by the arrow) to operate the bellows-type air pump 401 to pump lair into the air chambers 11″″ of the cooler via one or more connecting orifices 403 (one shown), to thereby inflate the air chamber(s) of the cooler.

In addition, the inflatable coolers of the present invention as described above may include graphics, text, logos or other information thereon printed directly onto the sidewalls, lid or other exterior surfaces of the cooler (for example, via silk screening or vinyl graphic printing). Such information may be print advertising, promotional advertising or other mass merchandising and marketing information.

Advantageously, the inflatable cooler of the present invention as described above provides the following benefits:

Keeps food or drink refreshingly cold for extended period of time (e.g., 24 to 72 hours)

Deflates, no bulk, saves storage or display space

Rolls up for easy storage in its own durable, reusable packaging

Inexpensive to Manufacture

Lightweight and Durable

Flat Smooth Printable Exterior

Stable and durable one-piece construction

Self-Contained Inflation Device

Insulates with Carbon Dioxide

Other embodiments of the invention will be apparent to those skilled in the art from consideration of the specification and practice of the invention disclosed herein. It is intended that the specification and examples be considered as examples only, with the true scope of the invention being indicated by the claims to Invention appended hereto.

I claim:

1. An inflatable cooler comprising:
at least one sidewall formed from a flexible plastic membrane having inflatable air chambers therein, said sidewall having an exterior surface, wherein the air chambers of the at least one sidewall act as a thermal insulating barrier for contents of the inflatable cooler; and
a flexible plastic membrane that, when removably disposed onto the exterior surface of the at least one sidewall, forms an exterior surface of the cooler suitable for printing information thereon.

2. The inflatable cooler of claim 1, wherein said information comprises one of text, graphics, and logos.

3. The inflatable cooler of claim 1, wherein said printing utilizes one of silk screening and vinyl graphic printing techniques.

4. The inflatable cooler of claim 1, wherein said inflatable cooler is provided to users with such information printed on this flexible plastic membrane.

5. The inflatable cooler of claim 1, wherein the flexible plastic membrane is shaped such that it surrounds the at least one sidewall and provides support for stress normal to the sidewall.

6. The inflatable cooler of claim 1, wherein said at least one sidewall is cylindrical in shape.

7. The inflatable cooler of claim 1, comprising a plurality of sidewalls.

8. The inflatable cooler of claim 1 further comprising an inflatable lid formed from a flexible plastic membrane having at least one inflatable air chamber therein, wherein the at least one air chamber of the lid act as a thermal insulating barrier for contents of the inflatable cooler.

9. The inflatable cooler of claim 8, wherein said at least one air chamber of the lid is designed so that the at least one air chamber in the center of the lid when inflated is deepest to provide maximum insulation against overhead sun.

10. The inflatable cooler of claim 8, wherein said lid comprises a smooth top suitable for printing information thereon.

11. The inflatable cooler of claim 1, further comprising an inflatable lid and bottom wall that is integral to the at least one sidewall, thereby forming a one-piece construction.

12. The inflatable cooler of claim 1, wherein said air chambers are formed by welding the flexible plastic membrane.

13. The inflatable cooler of claim 12, wherein welding the flexible plastic membrane utilizes one of thermal welding, adhesive welding or high frequency welding techniques.

14. The inflatable cooler of claim 1, wherein said flexible plastic membrane comprises a polyvinyl chloride (PVC) membrane.

15. The inflatable cooler of claim 1, wherein said flexible plastic membrane is less than 10 mils thick.

16. The inflatable cooler of claim 15, wherein said flexible plastic membrane is between 5-10 mils thick.

17. The inflatable cooler of claim 1, wherein the air chambers are inflated with carbon dioxide by a user blowing into one or more valves in fluid communication with said air chambers.

18. The inflatable cooler of claim 1, wherein the air chambers are inflated with an external air pump that pumps air into one or more valves in fluid communication with the air chambers of the cooler.

19. The inflatable cooler of claim 1, wherein the air chambers are inflated with an integral air pump that pumps air into the air chambers.

20. The inflatable cooler of claim 19, wherein said air pump is integral to a base of said cooler.

21. The inflatable cooler of claim 19, wherein said air-pump comprises a bellow-type air Pump.

22. An inflatable cooler comprising at least one sidewall formed from a flexible plastic membrane having inflatable air chambers therein, wherein base of said at least one sidewall has a larger dimension than a top opening formed by said at least one sidewall.

23. The inflatable cooler of claim 22, comprising a plurality of sidewalls that have a pyramid shape.

24. The inflatable cooler of claim 22, comprising a sidewall that has a conical section shape.

25. The inflatable cooler of claim 22, further comprising a flexible plastic membrane that, when removably disposed onto an exterior surface of the at least one sidewall, forms an exterior surface of the cooler suitable for printing information thereon.

26. The inflatable cooler of claim 25, wherein said information comprises one of text, graphics, and logos.

27. The inflatable cooler of claim 22, wherein said air chambers are formed by welding the flexible plastic membrane.

28. The inflatable cooler of claim 27, wherein welding the flexible plastic membrane utilizes one of thermal welding, adhesive welding or high frequency welding techniques.

29. The inflatable cooler of claim 22, wherein said flexible plastic membrane comprises a polyvinyl chloride (PVC) membrane.

30. The inflatable cooler of claim 22, wherein said flexible plastic membrane is less than 10 mils thick.

31. The inflatable cooler of claim 30, wherein said flexible plastic membrane is between 5-10 mils thick.

32. The inflatable cooler of claim 22, wherein the air chambers are inflated with carbon dioxide by a user blowing into one or more valves in fluid communication with said air chambers.

33. The inflatable cooler of claim 22, wherein the air chambers are inflated with an external air pump that pumps air into one or more valves in fluid communication with the air chambers of the cooler.

34. The inflatable cooler of claim 22, wherein the air chambers are inflated with an integral air pump that pumps air into the air chambers.

35. The inflatable cooler of claim 34, wherein said air pump is integral to a base of said cooler.

36. The inflatable cooler of claim 34, wherein said air-pump comprises a bellow-type air pump.
